(19) United States
(12) Patent Application Publication
(10) Pub. No.: US 2026/0036146 A1
(43) Pub. Date: Feb. 5, 2026

(54) AIRFOILS HAVING INTERNAL VIBRATIONAL DAMPERS

(71) Applicant: General Electric Company, Schenectady, NY (US)

(72) Inventors: Ravindra Shankar Ganiger, Bengaluru (IN); Nicholas J. Kray, Mason, OH (US); Hiranya Kumar Nath, Bengaluru (IN)

(21) Appl. No.: 18/677,233

(22) Filed: May 29, 2024

(51) Int. Cl. F04D 29/66; F01D 5/16; F01D 9/04; F04D 29/38

(52) U.S. Cl. CPC F04D 29/668; F01D 5/16; F01D 9/041; F04D 29/388; F04D 29/666; F05D 2220/323; F05D 2220/36; F05D 2240/12; F05D 2240/30; F05D 2260/96

(57) ABSTRACT

Airfoils for turbo engines with internal vibrational dampers are disclosed herein. An example airfoil includes an outer shell body defining an interior cavity. The airfoil includes a recess formed on a surface of a structure in the interior cavity and an opening in the structure at a center of the recess. The recess results in a thickness of the structure that decreases toward the center according to a power-law profile to concentrate vibrational waves toward the center and reduce vibrations in the airfoil.

### FIELD OF THE DISCLOSURE

The present disclosure relates generally to aircraft turbo engines and, more particularly, to airfoils for turbo engines having internal vibrational dampers.

### BACKGROUND

Aircraft engines (e.g., turbofan engines, turboprop engines, etc.) typically include a fan and a gas turbine engine (sometimes referred to as an engine core) to drive the fan to produce thrust. The gas turbine engine includes one or more compressor sections, a combustor, and one or more turbine sections in a serial flow arrangement. The fan includes one or more fan blades. Further, in some types of engines, there are outlet guide vanes disposed downstream of the fan. Some airfoils in the engine, such as the fan blades and outlet guide vanes, are susceptible to mechanical vibrations that are excited by acoustic energy.

### BRIEF DESCRIPTION OF THE DRAWINGS

A full and enabling disclosure of the presently described technology, including the best mode thereof, directed to one of ordinary skill in the art, is set forth in the specification, which makes reference to the appended FIGS., in which:

FIG. 1 is a schematic cross-sectional view of an example turbo engine in which examples disclosed herein can be implemented.

FIG. 2 is a side view of an example airfoil of the example turbo engine of FIG. 1 and in which any of the example vibrational dampers disclosed herein can be implemented.

FIG. 3 is a side view of the example airfoil of FIG. 2 including a first example of vibrational dampers implemented as beams.

FIG. 4 is a cross-sectional view of the example airfoil of FIG. 3 showing two of the example beams.

FIG. 5A illustrates a first example profile of one of the example beams of FIG. 3.

FIG. 5B illustrates a second example profile of one of the example beams of FIG. 3.

FIG. 6 is a side view of the example airfoil of FIG. 2 including a second example of vibrational dampers implemented as circular recesses.

FIG. 7 is an enlarged perspective view of one of the example circular recesses of FIG. 7.

FIG. 8 is a cross-sectional view of one of the example circular recesses of FIG. 6 having an example central opening or hole.

FIG. 9 is a cross-sectional view similar to FIG. 8 in which the example opening or hole is filled with a damping material.

FIG. 10 is a perspective view of a third example of vibrational dampers that can be implemented in the example airfoil of FIG. 2. The vibrational dampers are implemented as example posts and an example corrugated sheet.

FIG. 11 is a cross-sectional view of the example airfoil with the example posts and the example corrugated sheet of FIG. 10.

FIG. 12 is cross-sectional view of the example airfoil of FIG. 2 having another arrangement of example posts and an example corrugated sheet.

FIG. 13 is cross-sectional view of the example airfoil of FIG. 2 having example posts and two example corrugated sheets.

FIG. 14 illustrates another example shape or profile of a corrugated sheet.

FIG. 15A illustrates an example shape or profile of a corrugated sheet.

FIG. 15B illustrates another example shape or profile of a corrugated sheet.

FIG. 15C illustrates another example shape or profile of a corrugated sheet.

FIG. 15D illustrates another example shape or profile of a corrugated sheet.

FIG. 16 is a perspective view of the example posts and an example corrugated sheet having another example shape or profile.

FIG. 17 is a top view of the example posts and the example corrugated sheet of FIG. 16.

FIG. 18 is a cross-sectional view of the example airfoil of FIG. 2 having example posts used in combination with example hairpin structures.

FIG. 19 shows another example of the example posts in combination with other example hairpin structures.

The figures are not to scale. Instead, the thickness of regions may be enlarged in the drawings. In general, the same reference numbers will be used throughout the drawing(s) and accompanying written description to refer to the same or like parts.

### DETAILED DESCRIPTION

Turbo engines (e.g., turbofan engines, turboprop engines, etc.), such as those used on aircraft, typically include a fan and a gas turbine engine to drive the fan to produce thrust. Some types of turbo engines, such as unducted turbine engines, include outlet guide vanes (OGVs) downstream of the fan. The fan blades and OGVs are often susceptible to vibrations caused by acoustic energy. In particular, the fan blades and OGVs are airfoils with an outer shell body that is hollow or substantially hollow inside. Due to the high speed operation of these airfoils, acoustic energy (e.g., pressure waves) can cause vibration in the airfoil. In particular, at certain resonant frequencies, these acoustic excitations can create mechanical vibrations and/or amplify existing mechanical vibrations of the airfoil. Such mechanical vibrations are undesired and can have adverse effects on the performance of the airfoil (e.g., affect the ability to properly produce thrust, cause wear to downstream mounts and trunnions, etc.), as well induce additional stresses on the airfoil that can affect the structural integrity of the airfoil (e.g., cause cracks).

Disclosed herein are airfoils that have internal vibrational dampers, also referred to herein as acoustic black hole (ABH) features, that can be used to eliminate or significantly reduce/dampen such mechanical vibrations caused by acoustic energy and other sources. More specifically, the example ABH features can receive and concentrate vibrations to a particular structure or point, which is then dampened and/or dissipated (e.g., into heat). As such, the amount of acoustic energy-induced vibrations in the outer shell of the airfoil is significantly reduced or eliminated. As used herein, an “acoustic black hole” feature refers to a component or feature (e.g., recess) on a component used for passively controlling mechanical vibration of an airfoil. In some examples, the ABH feature is implemented as a thin-walled structure, such as a beam, a panel, or a plate with a local inhomogeneity. The thin-walled structure is disposed within the interior cavity defined by the outer shell body of the airfoil. The inhomogeneity can be a variation of the geometric and/or material properties of the thin-walled structure according to a spatial power-law profile. Furthermore, the thin-walled structure can include one or more layers of viscoelastic materials. Such a thin-walled structure provides attenuation properties to form an ABH in the interior. The ABH features reduce the mechanical vibration that is transmitted from the airfoil to the ABH mechanically. When the thickness of the thin-walled structure reduces to zero, the wave speed decreases to zero. When the ABH feature has a non-zero residual thickness at its center, a viscoelastic layer is added in the thickness reducing section for the wave speed to decrease. Thus, in some examples, the ABH feature (e.g., thin-walled structure, etc.) is combined with lossy media (e.g., a viscoelastic layer) to improve structural vibration loss factors. In other words, the ABH features operate as a wave trap that extract and dissipate vibrational energy from the host medium (e.g., airfoil structure) without releasing or reflecting the energy.

One example of an ABH feature disclosed herein is a beam that is coupled to and cantilevered from a fixed structure in the interior cavity of the airfoil. For example, the beam can be coupled to and cantilevered from a forward spar or a rear spar in the interior cavity. In some examples, the airfoil includes multiple beams cantilevered from the same fixed structure or different fixed structure. Each beam has a uniform thickness portion, which is coupled to the fixed structure, and a variable thickness portion at the distal end of the beam. The variable thickness portion has a thickness that reduces or tapers to the distal end according to a power-law profile. Acoustic energy-induced vibrations (as well as other vibrations) in the airfoil are transferred to the beam. Vibrations in the beam travel toward the distal end of the beam where the energy is concentrated. The geometric shape of the beam reduces the wave speed to zero or substantially zero. Hence, the acoustic/aeromechanical feedback energy is reduced completely or significantly. In some examples, a damping material such as a viscoelastic material is disposed on the beam at or near the distal tip. The damping material absorbs the oscillation of the distal tip and dissipates the energy as heat. As such, the beam reduces vibrations in the airfoil.

Another example of an ABH feature disclosed herein is a recess or indentation formed on a surface of a structure inside the interior cavity of the airfoil. For example, the recess can be formed on an inner surface of a side panel of the airfoil, on a spar inside the interior cavity, on the beam mentioned above, etc. In some examples, the recess is circular. In some examples, the airfoil includes a plurality of circular recesses formed on the various surfaces inside the interior cavity of the airfoil. Each circular recess has a profile in which the thickness of the structure is reduced to zero or close to zero according to a power-law profile. As such, the vibrational energy is concentrated toward the center of the circular recess where the wave speed is reduced to zero or substantially zero similar to the beam disclosed above. In some examples, the center of the circular recess has a hole or opening, which may be filled with viscoelastic material to help further dampen the vibrations concentrated at the center of the circular recess.

Another example vibration damping feature disclosed herein includes one or more posts in the interior cavity that are coupled to and cantilevered from a root of the airfoil. In some examples, a corrugated plate or sheet is disposed in the interior cavity and engaged with the posts (e.g., weaved in between the posts). Vibrations of the airfoil cause vibrations of the posts, which rub on the corrugated sheet, and vice versa. These mechanical vibrations are eliminated or significantly reduced via the frictional damping caused by the interaction between the posts and the sheet. Thus, the example vibration damping features disclosed herein dampen vibration energy caused by acoustic oscillations in the airfoil. As such, the example vibration damping features disclosed herein reduce the adverse effects and/or vibrational damage that may otherwise be imported to an airfoil of a turbo engine. While many of the example vibration damping features are disclosed in connection with a fan blade or an OGV, the example airfoils with vibration damping features can be implemented as any type of airfoil implemented in a turbo engine, such as a rotor blade in a compressor or a turbine, a stator vane in a compressor turbine, or an inlet guide vane.

Reference now will be made in detail to examples or embodiments of the presently described technology, one or more examples of which are illustrated in the drawings. Each example or embodiment is provided by way of explanation of the presently described technology, not limitation of the presently described technology. In fact, it will be apparent to those skilled in the art that various modifications and variations can be made in the presently described technology without departing from the scope or spirit of the presently described technology. For instance, features illustrated or described as part of one example or embodiment can be used with another example or embodiment to yield a still further example or embodiment. Thus, it is intended that the presently described technology covers such modifications and variations as come within the scope of the appended claims and their equivalents.

The terms “upstream” and “downstream” refer to a relative location or direction with respect to fluid flow between an upstream location or source of fluid and a downstream location or end location of the fluid. For example, “upstream” refers to a location that is relatively closer to or in a direction that is toward the upstream location or source of fluid, whereas “downstream” refers to a location that is relatively closer to or in a direction toward the downstream location or end location of the fluid. As used herein, the terms “axial” and “longitudinal” both refer to a direction parallel to the centerline axis of a gas turbine engine (e.g., a turboprop, a core gas turbine engine, etc.), while “radial” refers to a direction perpendicular to the axial direction, and “tangential” or “circumferential” refers to a direction mutually perpendicular to the axial and radial directions. Accordingly, as used herein, “radially inward” refers to a relative location or direction along a radial line from the outer circumference of the gas turbine engine towards the centerline axis of the gas turbine engine, and “radially outward” refers to a relative location or direction along a radial line from the centerline axis of the gas turbine engine towards the outer circumference of the gas turbine engine.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

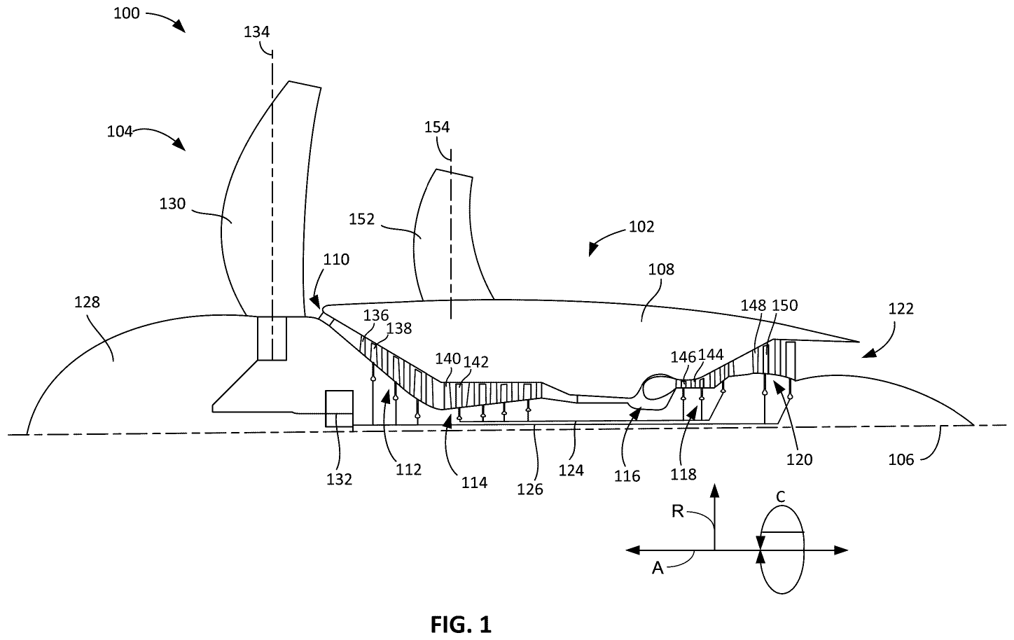

Referring now to the drawings, FIG. 1 is a schematic cross-sectional view of an example turbo engine 100 that can incorporate various examples disclosed herein. The example turbo engine 100 can be implemented on an aircraft and can therefore be referred to as an aircraft engine. The turbo engine 100 includes a gas turbine engine 102 (sometimes referred to as an engine core) and a fan 104 driven by the gas turbine engine 102 to produce forward thrust. In this example, the turbo engine 100 is an unducted turbine engine, also referred to sometimes as a turboprop engine or open rotor engine. This type of engine does not include a nacelle or cowl around the fan 104. However, any of the example teachings disclosed herein can also be implemented in connection with other configurations of engines such as turbofan engines, turbojet engines, etc. Further, the example teachings disclosed herein can be implemented on other types of engines, such as non-aircraft engines (e.g., power generation engines).

As shown in FIG. 1, the turbo engine 100 and/or the gas turbine engine 102 define a longitudinal or axial centerline axis 106 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 106, the radial direction R is a direction that extends orthogonally outward from or inward toward the centerline axis 106, and the circumferential direction C is a direction that extends concentrically around the centerline axis 106. Further, as used herein, the term “forward” refers to a direction along the centerline axis 106 in the direction of movement of the turbo engine 100, such as to the left in FIG. 1, while the term “rearward” refers to a direction along the centerline axis 106 in the opposite direction, such as to the right in FIG. 1.

The gas turbine engine 102 includes a substantially tubular casing 108 (which may also be referred to as a core cowl) that defines an annular inlet 110. The casing 108 of the gas turbine engine 102 can be formed from a single casing or multiple casings coupled together. The casing 108 encloses, in serial flow relationship, a compressor section having a booster or low pressure compressor 112 (“LP compressor 112”) and a high pressure compressor 114 (“HP compressor 114”), a combustion section 116 (which may also be referred to as the combustor 116), a turbine section having a high pressure turbine 118 (“HP turbine 118”) and a low pressure turbine 120 (“LP turbine 120”), and an exhaust section 122.

The gas turbine engine 102 includes a high pressure shaft 124 (“HP shaft 124”) that drivingly couples the HP turbine 118 and the HP compressor 114. The gas turbine engine 102 also includes a low pressure shaft 126 (“LP shaft 126”) that drivingly couples the LP turbine 120 and the LP compressor 112. The LP shaft 126 also couples to a fan hub 128. The fan 104 includes a plurality of fan blades 130 (sometimes referred to as propeller blades) that are coupled to and extend radially outward from the fan hub 128. In some examples, the LP shaft 126 may couple directly to the fan hub 128 (e.g., a direct-drive configuration). In alternative configurations, the LP shaft 126 may couple to the fan hub 128 via a gearbox or transmission 132 (e.g., a gear reduction). In this example, the fan blades 130 are variable, meaning the pitch of the fan blades 130 can be varied. For examples, each of the fan blades 130 can rotate about a respective radial axis 134.

While in this example the gas turbine engine 102 includes two compressors and two turbines, in other examples, the gas turbine engine 102 may only include one compressor and one turbine. Further, in other examples, the gas turbine engine 102 can include more than two compressors and turbines. In such examples, the gas turbine engine 102 may include more than two drive shafts or spools.

During operation of the turbo engine 100, air is accelerated by the fan blades 130. A portion of the air flows into the annular inlet 110 of the gas turbine engine 102 and into the LP compressor 112. One or more sequential stages of LP compressor stator vanes 136 and LP compressor rotor blades 138 coupled to the LP shaft 126 progressively compress the air flowing through the LP compressor 112 en route to the HP compressor 114. Next, one or more sequential stages of HP compressor stator vanes 140 and HP compressor rotor blades 142 coupled to the HP shaft 124 further compress the air flowing through the HP compressor 114. This provides compressed air to the combustion section 116 where the air is mixed with fuel and ignited to produce high pressure combustion gases.

The combustion gases flow through the HP turbine 118 where one or more sequential stages of HP turbine stator vanes 144 and HP turbine rotor blades 146 coupled to the HP shaft 124 extract a first portion of kinetic and/or thermal energy. This energy extraction supports operation of the HP compressor 114. The combustion gases then flow through the LP turbine 120 where one or more sequential stages of LP turbine stator vanes 148 and LP turbine rotor blades 150 coupled to the LP shaft 126 extract a second portion of thermal and/or kinetic energy therefrom. This energy extraction causes the LP shaft 126 to rotate, which supports operation of the LP compressor 112 and rotation of the fan hub 128 and, therefore, rotating the fan blades 130 to produce forward thrust. The combustion gases then exit the gas turbine engine 102 through the exhaust section 122 thereof, which also produces forward thrust.

In the illustrated example, the turbo engine 100 also includes outlet guide vanes (OGVs) 152 coupled to and extending radially outward from the casing 108. The OGVs 152 are downstream of the fan 104. The air exiting the fan 104 is partially swirling in a circumferential direction. The OGVs 152 help to redirect the air to a more rearward or axial direction to provide forward thrust. In this example, the OGVs 152 are variable, meaning they can pitch about their radial axis 154. However, in other examples the OGVS may be non-variable.

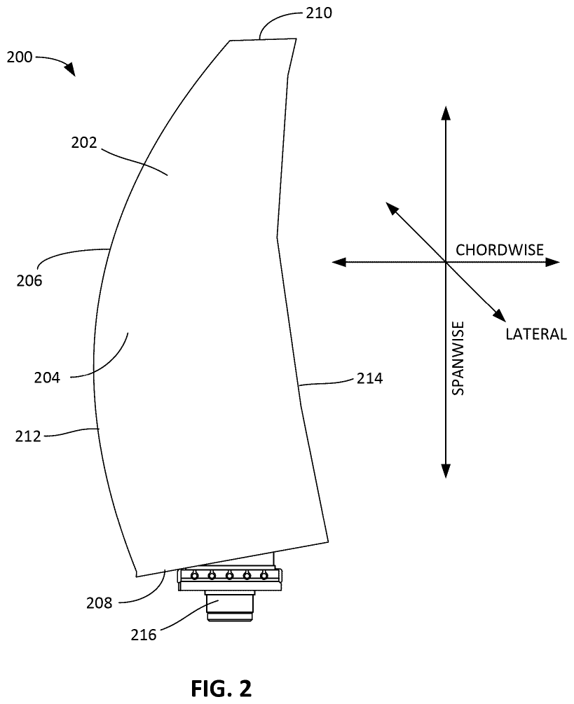

FIG. 2 illustrates an example airfoil 200 that can be implemented on the example turbo engine 100 of FIG. 1. Various ABH features are disclosed in connection with the airfoil 200 in the description below. The airfoil 200 can correspond to any airfoil implemented in the turbo engine 100 of FIG. 1. For example, the airfoil 200 may correspond to one of the fan blades 130, one of the OGVs 152, or one of the internal rotor blades or stator vanes.

In the illustrated example, the airfoil 200 has an outer shell body 202 that forms or defines a hollow or substantially hollow interior cavity. One or more support structures (e.g., spars, ribs, etc.) may be located in the interior cavity, as disclosed in further detail herein. The outer shell body 202 may be constructed of one or more panels that form the general shape of the airfoil 200. For example, the outer shell body 202 includes a first side panel 204 forming a first side of the airfoil 200 and a second side panel 206 forming a second side of the airfoil 200 opposite the first side. Each of the first and second side panels 204, 206 can be formed by one single panel or multiple panels coupled together. The first and second side panels 204, 206 extend lengthwise (in the radial R direction (FIG. 1)) between a root 208 and a tip 210 of the airfoil 200. This direction between the root 208 and the tip 210 is also referred to herein as the spanwise direction. The first and second side panels 204, 206 also extend (in the axial A direction (FIG. 1)) between a leading edge 212 and an aft edge 214 of the airfoil 200. This direction between the leading edge 212 and the aft edge 214 is also referred to herein as the chordwise direction. The airfoil 200 also has a lateral direction that extends perpendicular to the spanwise direction and the chordwise direction. The first and second side panels 204, 206 can be separate panels coupled together (e.g., at or along the leading and aft edges 212, 214) or may be constructed as a single panel that is bent or otherwise shaped to form the airfoil 200. The outer shell body 202 can be constructed of a metal or a non-metal material. For example, the first and second side panels 204, 206 may be aluminum or another light weight metal or metal alloy. In other examples, the first and second side panels 204, 206 can be constructed of a compositive material, such as carbon composite material. In the illustrated example, the airfoil 200 includes a trunnion 216 coupled to the root 208. The trunnion 216 forms a bearing for rotating/pitching the airfoil 200. In other examples, the airfoil 200 may not include a trunnion 216.

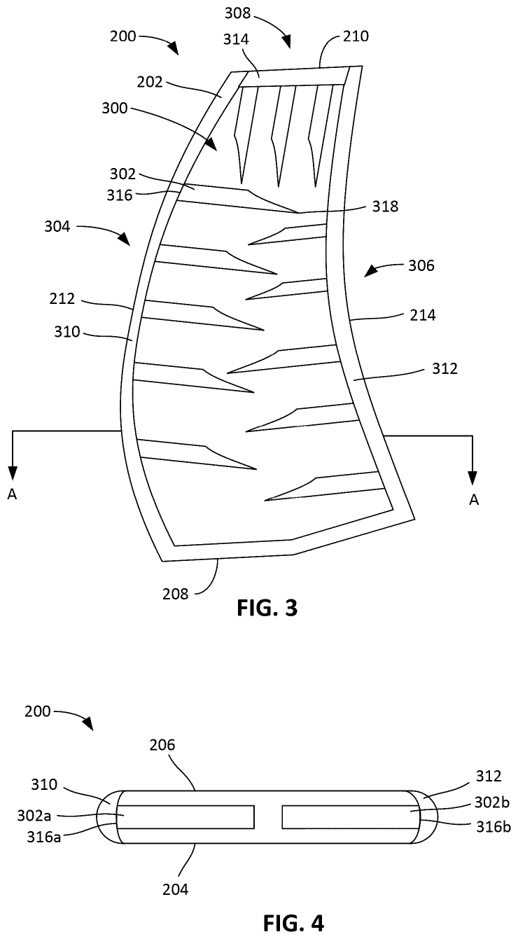

FIG. 3 is side view of the airfoil 200 of FIG. 2 in which the first side panel 204 (FIG. 2) has been removed to expose an interior cavity 300 of the airfoil 200 formed or defined by the outer shell body 202. The airfoil 200 includes ABH features to absorb, dampen, and/or otherwise reduce acoustic energy-induced vibrations in the airfoil 200. In this example, the ABH features are implemented as beams 302 (one of which is referenced in FIG. 3) in the interior cavity 300 of the airfoil 200. As disclosed in further detail, the beams 302 are coupled to and cantilevered from fixed structures in the interior cavity 300. Acoustic waves cause the beams 302 to oscillate or vibrate, which converts acoustic energy into vibrational energy and heat (e.g., within the air and/or the beams 302), and which therefore dissipates the acoustic energy.

In the illustrated example, the airfoil 200 includes a first set 304 of the beams 302 that extend from the leading edge 212, a second set 306 of the beams 302 that extend from the aft edge 214, and a third set 308 of the beams 302 that extend from the tip 210. However, in other examples, the airfoil 200 may have beams extending from only one or two of these regions. Additionally or alternatively, the airfoil 200 can include beams extending from other regions, such as extending from the root 208. The airfoil 200 may include any number of beams (e.g., one, two, three, etc.).

In some examples, the beams 302 are coupled to and extend from one or more internal structures in the interior cavity 300, such as spars. For example, in FIG. 3, the airfoil 200 includes a forward spar 310, which is an internal support structure in the interior cavity 300 of the airfoil 200. In some examples, the first and second side panels 204, 206 are coupled (e.g., via rivets) to the forward spar 310. The first set 304 of the beams 302 are coupled to and cantilevered from the forward spar 310. The beams 302 may be coupled to the forward spar 310 by welding, fasteners, adhesives, etc. and/or integrally formed with the forward spar 310. Similarly, the second set 306 of the beams 302 is coupled to and cantilevered from a rear spar 312 in the interior cavity 300. Further, the third set 308 of the beams 302 are coupled to and extend from a tip spar 314 in the interior cavity 300. In this example, each of the beams 302 is cantilevered from a fixed structure (e.g., a spar). For example, each of the beams 302 has a root end 316 coupled to the fixed structure and a distal end 318 (e.g., a tip) that is free. This enables the beams 302 to vibrate and therefore absorb/dampen acoustic energy. In some examples, the beams 302 are constructed of metal such as titanium, aluminum, or a titanium aluminum alloy, or another type of material such as a hybrid composite material.

FIG. 4 is a cross-sectional view of the airfoil 200 taken along line A-A of FIG. 3. As shown, a first beam 302a is coupled to the forward spar 310 at its root end 316a. Further, the first beam 302a is spaced from the first and second side panels 204, 206. Similarly, a second beam 302b is coupled to the rear spar 312 at its root end 316b and is spaced from the first and second side panels 204, 206. The beams 302 can extend any distance. In some examples, such as if the airfoil 200 has a central spar, the beams 302 may not extend beyond the center of the airfoil 200.

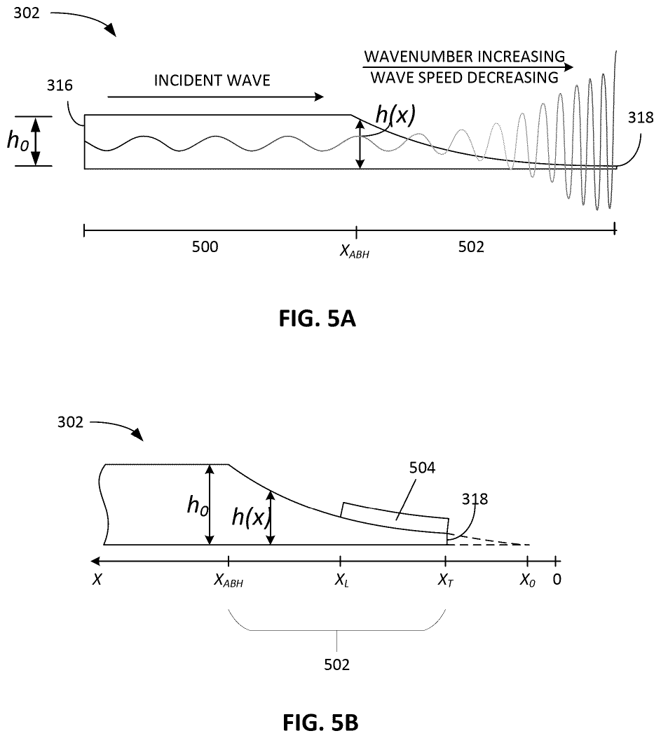

FIG. 5A is a side view of an example of one of the beams 302. The beam 302 has the root end 316, which is the end coupled to a fixed structure (e.g., a spar), and the distal end 318, which is the free end. As shown, the beam 302 has a first portion, referred to herein as a uniform portion 500, and a second portion, referred to herein as an ABH portion 502. The uniform portion 500 is the portion coupled to the fixed structure, while the ABH portion 502 forms the free or distal end 318. As shown in FIG. 5A, the uniform portion 500 has a uniform or constant thickness ho, and the ABH portion 502 has a thickness h(x) that reduces from the uniform portion 500, at X_{ABH}, to the distal end 318. Acoustic energy causes vibration of the airfoil 200, which is transmitted to and causes the beam 302 to vibrate. The vibration is transmitted as an incident wave through the uniform portion 500 to the ABH portion 502 toward the distal end 318. As shown in FIG. 5A, as the wave travels through the ABH portion 502 toward the distal end 318, the wavenumber (e.g., frequency) of the wave increases while the wave speed decreases. As such, the distal end 318 vibrates rapidly. This essentially concentrates the vibrations to the distal end 318, which reduces (e.g., dampens) vibrations on the outer shell body 202 and other structures of the airfoil 200.

In the illustrated example, the ABH portion 502 has a thickness h(x) that decreases from X_{ABH} to the distal end 318 according to a non-linear profile. In particular, in this example, the thickness h(x) reduces according to a power-law profile. In a power-law profile, the relative change in one quantity gives rise to a change in another quantity proportional to a power of the change. For example, in this example, the power-law profile is represented by h(x)=kx^{m}, where m is a real constant defining the power-law profile, x is an axial coordinate along beam 302, and k is a constant. Therefore, the thickness h(x) is based on the axial coordinate x to the m^{th} power. If the real constant m is less than one, the thickness h(x) decreases along the axial coordinate x. In some examples, according the power-law profile, the thickness of the ABH portion 502 decreases to a thickness of zero or as close to zero as possible (e.g., based on material strength) at the distal end 318, such that the wave speed decreases to zero or close to zero.

In some instances, it may be difficult or impractical to manufacture and/or maintain a beam with an ABH portion that tapers to a thickness of zero or close to zero because of its material properties. Therefore, in some examples, the distal end 318 can be truncated or shorted. For example, FIG. 5B shows an alternative profile that can be implemented by one or more of the beams 302. In this example, the distal end 318 of the beam 302 is truncated or shorted compared to the distal end 318 in FIG. 5A. As such, the distal end 318 in FIG. 5B has a larger thickness than the thickness in FIG. 5A. This truncation enables the beam 302 to maintain its structural form without risk of the tip portion breaking or fracturing. Further, in some examples, a damping material 504 is applied to a surface of the beam 302. For example, as shown in FIG. 5B, the damping material 504 is coupled to or layered on the beam 302 along the ABH portion 502 and extends till the distal end 318. As mentioned above, vibrational waves are transmitted through the beam 302 toward the distal end 318, which cause the distal end 318 to vibrate or oscillate rapidly. By applying damping material 504 at or near the distal end 318, the damping material 504 absorbs these vibrations/oscillations and dissipates the energy as heat into the surrounding air. Therefore, the damping material 504 drastically reduces the reflection coefficient even in the presence of a truncated profile. Thus, mechanical vibrations in the airfoil 200 are transferred to the beam 302, and the beam 302 dampens these mechanical vibrations by means of the thickness profile of the beam 302 and the damping material 504. In some examples, the damping material 504 is constructed of a viscoelastic material such as a shape memory alloy (SMA) or polymer. Additionally or alternatively, the damping material 504 can include other types of materials such as foam, vinyl, and/or polytetrafluoroethylene (e.g., Teflon®).

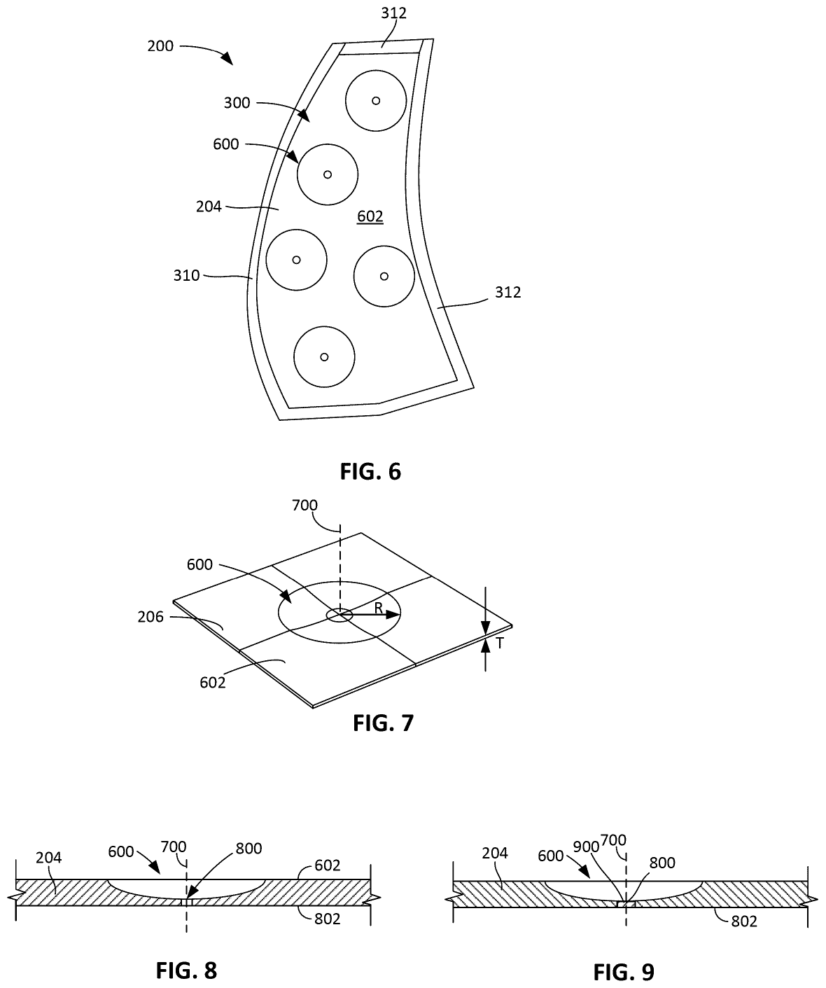

FIG. 6 illustrates another example ABH feature that can be implemented in the airfoil 200. FIG. 6 is side view of the airfoil 200 of FIG. 2 in which the first side panel 204 (FIG. 2) has been removed to expose the interior cavity 300 of the airfoil 200. In this example, the ABH features are implemented as recesses 600 (e.g., indentations) (one of which is referenced in FIG. 6) formed on a surface of a structure in the interior cavity 300 of the airfoil 200. For example, in this example, the recesses 600 are formed on an inner surface 602 of the second side panel 206. The second side panel 206 can include a plurality of recesses 600 formed on the inner surface 602. In the example shown in FIG. 6, the second side panel 206 includes five recesses 600. However, the airfoil 200 can include any number (e.g., one, two, three, etc.) of recesses 600 on the inner surface 602 of the second side panel 206. In some examples, the first side panel 204 (FIG. 2) may similarly include one or a plurality of recesses 600 formed on an inner surface of the first side panel 204. In the illustrated example, the recesses 600 are circular.

FIG. 7 is an enlarged view of one of the recesses 600 formed on the inner surface 602 of the second side panel 206 (a structure). In this example the recess 600 is circular. The recess 600 extends into the thickness (t) of the second side panel 206. The recess 600 has a radius (r). The recess 600 defines or results in a tapering or narrowing of the thickness (t) toward a center 700 of the recess 600. In some examples, d(t)/d(r)>0 according to a power-law profile, similar to the ABH portion 502 of the beam 302 in FIGS. 5A and 5B. Therefore, in some examples, the thickness (t) narrows in a non-linear manner to a thickness of zero or close to zero at the center 700.

FIG. 8 is a cross-sectional view of the second side panel 206 taken through the recess 600. As shown from this view, because of the recess 600, the second side panel 206 has substantially the same profile as the beam 302 disclosed in connection with FIGS. 3-5B. In particular, the recess 600 defines or results in a thickness of the second side panel 206 that decreases toward the center 700 according to a power-law profile to concentrate incident waves toward the center 700 and reduce vibrations in the airfoil 200. In some examples, the recess 600 defines or results in a thickness that decreases toward the center 700 according to the power-law profile h(x)=kx^{m}.

In some examples, as shown in FIG. 8, the second side panel 206 has an opening 800 at the center 700, which extends between the inner surface 602 and an outer surface 802 of the second side panel 206. The opening 800 truncates or shortens the narrowing thickness profile. In this example, the recess 600 with the opening 800 defines or results in a thin disc-shaped structure. The profile formed by the recess 600 and the opening 800 dampens vibrations caused by acoustic energy in the airfoil 200. In particular, acoustic energy in the airfoil 200 imparts vibrations in the second side panel 206. The incident waves cause vibrations that are concentrated toward the thin area near the center 700, which reduces the wave speed of the incident waves to zero or close to zero, thus eliminate or reducing acoustical vibrations in the airfoil 200 similar to the beams 302 disclosed above. As such, the profile or shape formed by the recess 600 and the opening 800 dampens vibrations caused by acoustic energy in the airfoil 200.

As shown in FIG. 8, the opening 800 extends through the second side panel 206 between the inner surface 602 and the outer surface 802. In some examples, the opening 800 is left open. However, in other examples, the opening 800 can be filled with a damping material. For example, FIG. 9 shows an example in which the opening 800 is filled with viscoelastic material 900 (e.g., polyurethane foam, rubber, polymers, elastomers, hydrogel, etc.). Use of the viscoelastic material 900 ensures the outer surface 802 of the second side panel 206 does not have any holes that could adversely affect airflow. Further, the viscoelastic material 900 helps to dampen vibrations at the center 700 of the recess 600, similar to the damping material 504 disclosed in connection with FIG. 5B. In particular, the viscoelastic material 900 dissipates the vibrational energy as heat.

In addition to or as an alternative to the recesses 600 on the side panels 204, 206, one or more other surfaces in the interior cavity 300 of the airfoil 200 can include one or more recesses 600. For example, one or more recesses 600 can be formed on surfaces of the forward spar 310, the rear spar 312, the tip spar 314, an internal rib, an internal plate, and/or other any other surface of an internal structure of the airfoil 200. In some examples, the recesses 600 can be used in combination with the beams 302 disclosed in connection with FIGS. 3-5B. For example, the airfoil 200 can include one or more beams 302 extending from the spar(s), and can include one or more recesses 600 formed on the side panels 204, 206 or another surface in the interior cavity 300. In some examples, one or more recesses 600 can be formed on the beam 302, such as on the uniform portion 500 of the beam 302. In some examples, the recesses 600 have a first power-law profile, and the beams 302 have a second power-law profile. In some examples, the first and second power-law profiles are the same. In other examples, the first and second power-law profiles are different (e.g., different real constant m). While the example recesses 600 shown in FIG. 6 are circular shaped, in other examples the recesses 600 could be shaped differently, such as elliptical or polygonal shaped recesses.

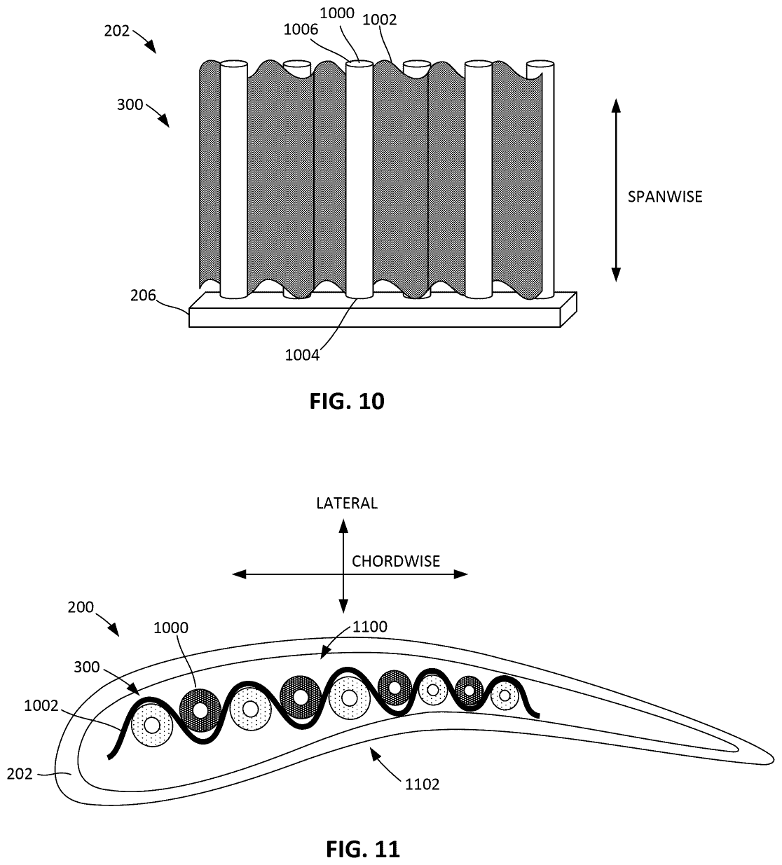

FIG. 10 illustrates another example vibration damping feature that can be implemented in the airfoil 200. In this example, the vibration damping feature is implemented as a plurality of posts 1000 (one of which is referenced in FIG. 10) and a corrugated plate or sheet 1002 in the interior cavity 300 of the airfoil 200. FIG. 10 shows the example root 208 and a plurality of posts 1000 coupled to and extending (in the spanwise direction) from the root 208. The side panels 204, 206 (FIG. 2) of the airfoil 200 have been removed for clarity.

In the illustrated example of FIG. 10, the posts 1000 are coupled to and cantilevered from the root 208. For example, each of the posts 1000 has a root end 1004 that is coupled (e.g., via welding, fasteners, etc.) to the root 208 and a distal end 1006 that is free. In the illustrated example, the corrugated sheet 1002 has a wave-like profile formed by repeating curves. As shown in FIG. 10, each of the posts 1000 is arranged or disposed in a curve of the corrugated sheet 1002.

FIG. 11 is a cross-sectional view of the airfoil 200 showing the posts 1000 (one of which is referenced in FIG. 11) and the corrugated sheet 1002 in the interior cavity 300 of the airfoil 200. As shown, each of the posts 1000 is disposed in one of the curves of the corrugated sheet 1002 and engaged with the outer surface of the corrugated sheet 1002 along the respective curve. This arrangement increases (e.g., maximizes) surface contact between the posts 1000 and the corrugated sheet 1002. As such, each of the posts 1000 has multiple points of contact along the outer surface of the corrugated sheet 1002. In some examples, the corrugated sheet 1002 is not fixedly coupled to any structure of the airfoil 200. Instead, the corrugated sheet 1002 is loose or floating in the interior cavity 300. The arrangement of the posts 1000 limits or restricts the corrugated sheet 1002 from moving laterally or in the chordwise direction. However, the corrugated sheet 1002 may slide slightly along the posts 1000 in the spanwise direction (FIG. 2).

Vibrations in the airfoil 200 cause the posts 1000 to vibrate. These vibrations travel along the posts 1000 toward the distal ends 1006 (FIG. 10). Because the posts 1000 are in contact with the corrugated sheet 1002, vibrations in the posts 1000 are dampened through frictional rubbing between the posts 1000 and the corrugated sheet 1002.

In the illustrated example of FIG. 11, the posts 1000 are arranged such that a first set 1100 of the posts 1000 are disposed on one side of the corrugated sheet 1002 and a second set 1102 of the posts 1000 are disposed on the opposite side of the corrugated sheet 1002. As such, the posts 1000 are staggered in the chordwise direction. This arrangement increases (e.g., maximize) the number of posts 1000 that can be utilized. Further, this arrangement helps to limit or restrict the corrugated sheet 1002 from moving laterally.

In some examples, the posts 1000 are constructed of metal or non-metal materials (e.g., a composite material such as carbon fiber). For example, the posts 1000 can be extruded metal wires (e.g., copper wires). In other examples, the posts 1000 can be constructed of an elastomeric material, such as Viton. In some examples, the posts 1000 and/or the corrugated sheet 1002 are pre-strained. In some examples, certain ones of the posts 1000 are constructed of different material than other ones of the posts 1000. For example, the first set 1100 of the posts 1000 may be constructed of a first type of material, and the second set 1102 of the posts 1000 may be constructed of a second type of material different than the first type of material. The different materials can be used to dampen different vibrational frequencies. In some examples, the corrugated sheet 1002 is constructed of metal, such as titanium, aluminum, or nickel based alloys.

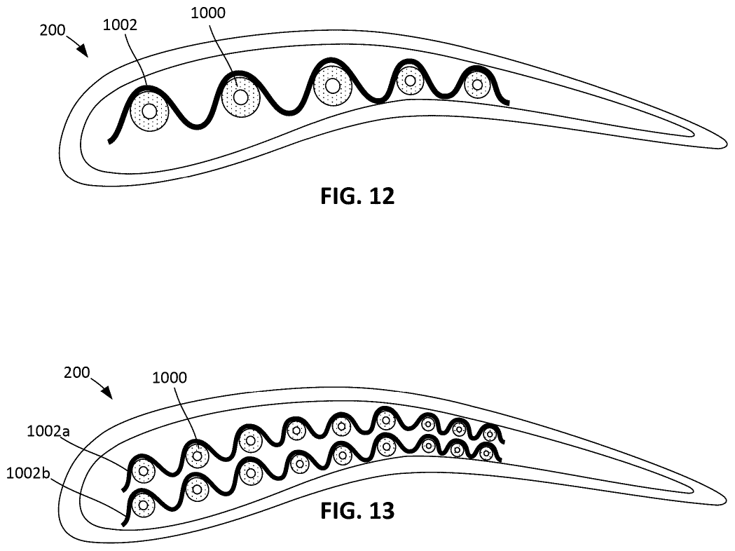

FIG. 12 illustrates another example arrangement of the posts 1000 and the corrugated sheet 1002. In this example, the posts 1000 are disposed only on one side of the corrugated sheet 1002.

In some examples, the airfoil 200 can include more than one corrugated sheet. For example, FIG. 13 shows an example in which the airfoil 200 has two corrugated sheets 1002a, 1002b. Further, in such examples, the airfoil 200 can include additional posts 1000 (one of which is referenced in FIG. 13) to support the additional corrugated sheets 1002a, 1002b.

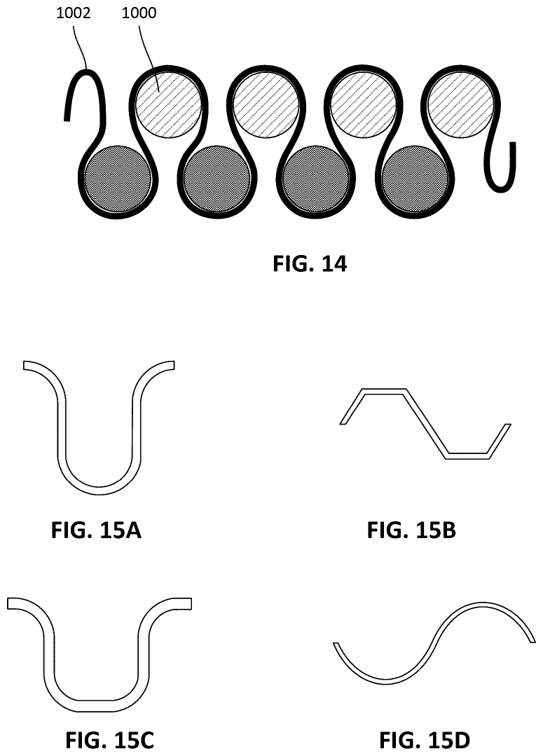

The corrugated sheet 1002 can have various shapes or profiles. For example, FIG. 14 illustrates an example in which the corrugated sheet 1002 has deeper curves. This enables the corrugated sheet 1002 to wrap further around (e.g., more than 180°) each of the posts 1000. This shape results in greater surface contact between the posts 1000 and the corrugated sheet 1002, which increases frictional damping. FIGS. 15A-15D show other example corrugated sheet profiles that can be implemented. These different shapes may result in different tuning/damping effects.

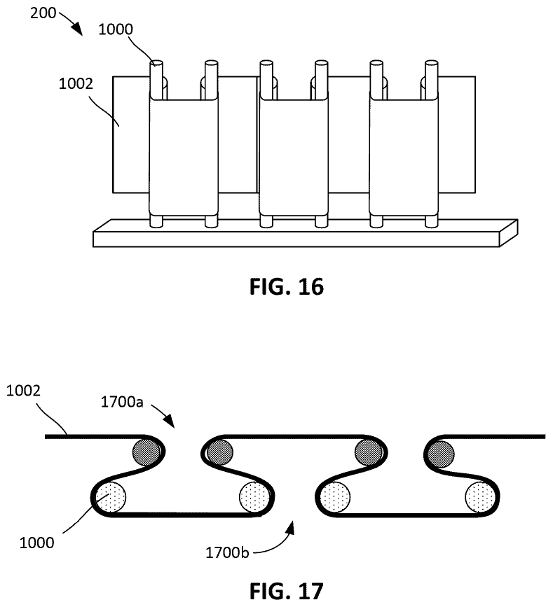

FIG. 16 is a perspective view of another example arrangement of the posts 1000 and the corrugated sheet 1002 that can be implemented in the airfoil 200. In this example, the corrugated sheet 1002 has a profile or shape in which portions of the curves of the corrugated sheet 1002 curve backward. FIG. 17 is a top view of the posts 1000 and the corrugated sheet 1002 of FIG. 16. The corrugated sheet 1002 has a repeating pattern of first curves 1700a and second curves 1700b in opposite directions. Two posts 1000 are disposed in each of the curves 1700a, 1700b. The profile in each of the curves 1700a, 1700b results in relatively high amount of surface contact between the posts 1000 and the corrugated sheet 1002 that increases frictional damping. In some examples, the corrugated sheet 1002 is pre-strained. As such, when the corrugated sheet 1002 is installed with the posts 1000, the corrugated sheet 1002 flexes into the posts 1000 to increase frictional damping.

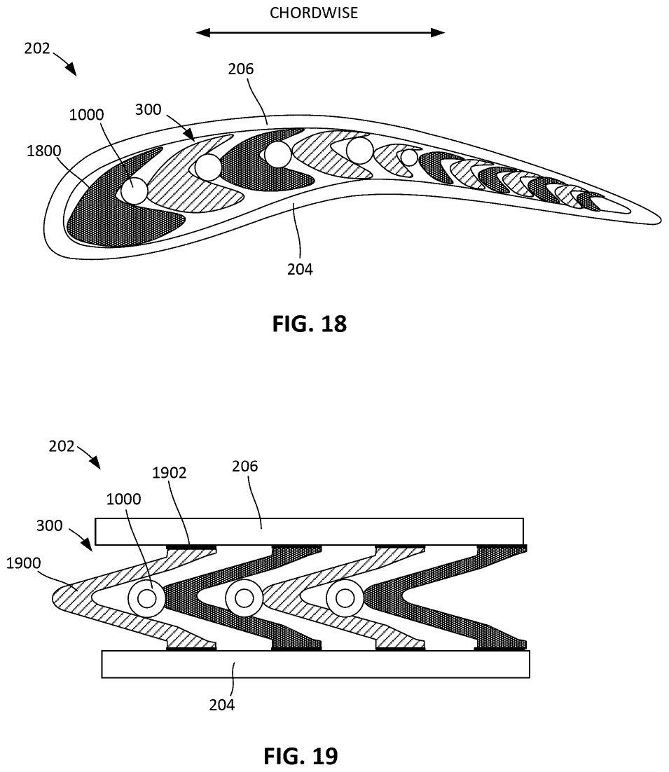

FIG. 18 is a cross-sectional view of the example airfoil 200 with another example internal arrangement of the posts 1000. In this example, the airfoil 200 includes hairpin structures 1800 in the interior cavity 300. Each of the hairpin structures 1800 extends spanwise (FIG. 2) from the root 208 (FIG. 2) to the tip 210 (FIG. 2). The example hairpin structures 1800 of FIG. 18 are “U”, “V”, and/or “C” shaped structures that are arranged chordwise in the interior cavity 300. Each of the hairpin structures 1800 is engaged with the first side panel 204 and the second side panel 206. The hairpin structures 1800 are at least partially flexible, which enables the hairpin structures 1800 to help absorb or dampen shocks and vibrations from the side panels 204, 206. The hairpin structures 1800 can be constructed of metal or non-metal materials, such as carbon nanotubes (CNT) impregnated with graphene, functionally graded material (FGM), or shape-memory alloy (SMA). In some examples, the hairpin structures 1800 alternate between two materials, such as a material with a higher stiffness and a material with a lower stiffness. For example, the first hairpin structure 1800 may have a first material with higher stiffness, the second hairpin structure 1800 may have a second material with a lower stiffness, the third hairpin structure 1800 may have the first material, the fourth material may have the second material, and so forth. In some examples, the hairpin structures 1800 are coupled to first and second side panels 204, 206, such as using fuse shears. In other examples, the hairpin structures 1800 are not coupled to the side panels 204, 206, but are free floating and can slide. The hairpin structures 1800 can move with respect to one another (e.g., by expanding and/or compressing the hairpin structures 1800). Because the hairpin structures 1800 are in contact and moving with respect of one another, the movement causes friction that to provide self-damping that absorbs energy and reduces stress propagation.

In the illustrated example, each of the posts 1000 is disposed between and engaged with two of the hairpin structures 1800 to dampen vibrations via frictional damping. In particular, each of the posts 1000 is disposed in the concave groove of one of the hairpin structures 1800. The posts 1000 are cantilevered from the root 208 (FIG. 2), as disclosed above. The contact between the posts 1000 and the hairpin structures 1800 provides frictional damping to reduce or eliminate vibrations in the airfoil 200.

FIG. 19 is a cross-sectional view of the example airfoil 200 with another example internal arrangement of the posts 1000 (one of which is referenced in FIG. 19). In this example, the airfoil 200 includes hairpin structures 1900 (one of which is referenced in FIG. 19) in the interior cavity 300 between the first and second side panels 204, 206. In the illustrated example, the hairpin structures 1900 are V-shaped structures with substantially constant wall thicknesses. The hairpin structures 1900 are arranged similar to the hairpin structures 1800 of FIG. 18. Each of the posts 1000 is arranged between two adjacent ones of the hairpin structures 1900. As such, each of the posts 1000 is in contact with two adjacent ones of the hairpin structures 1900. In the illustrated example, the airfoil 200 includes example fuses 1902 that couple the hairpin structures 1900 to the interior surfaces of the first and second side panels 204, 206. In some examples, the fuses 1902 are shear fuses. Shear fuses shear off (e.g., break) when more than a threshold amount of energy and/or load is applied to the airfoil 200. In this manner, the example hairpin structures 1900 can move with respect to the interior surfaces of the first and second side panels 204, 206 (e.g., laterally), which creates additional friction to vibrational energy absorption. The fuses 1902 can be created with weak diffusion bonding (e.g., by adding porosity to the fuse to make the fuse weaker). In some examples, some of the hairpin structures 1900 can be fused with regular fuses, and some of the hairpin structures 1900 can be fused with one or more types (e.g., corresponding to different strengths) of shear fuses.

Multiple vibrational dampers or ABH features have been disclosed herein that can be implemented in an airfoil. Any of the example ABH features can be combined. For example, any of the beam embodiments of FIG. 3-5B, the recess embodiment of FIGS. 6-9, and/or the post embodiments of FIGS. 10-19 can be combined and used in the same airfoil. For example, an airfoil can include one or more of the beams 302 of FIG. 3, one or more the recesses 600 of FIG. 6, and one or more of the posts 1000 of FIG. 10. In some examples, combining one or more of these ABH features results in improved vibrational damping.

From the foregoing, it can be appreciated that example ABH features have been disclosed that can be implemented in an airfoil to eliminate or significantly reduce mechanical vibrations imparted by acoustic energy in the airfoil. Because such vibrations are eliminated or significantly reduced, the airfoil can be constructed of thinner and/or lighter materials material, which reduces weight and costs associated with the airfoil. These self-damping airfoils also enable the elimination or reduction complex retention systems typically used with airfoils.

Further examples and example combinations thereof are provided by the subject matter of the following clauses:

An airfoil comprises an outer shell body defining an interior cavity, a recess formed on a surface of a structure in the interior cavity, and an opening in the structure at a center of the recess. The recess defines a thickness of the structure that decreases toward the center according to a power-law profile to concentrate vibrational waves toward the center and reduce vibrations in the airfoil.

The airfoil of any preceding clause, wherein the opening is filled with viscoelastic material.

The airfoil of any preceding clause, wherein the outer shell body includes a side panel, and wherein the surface is an inner surface of the side panel.

The airfoil of any preceding clause, further including a plurality of recesses formed on the inner surface of the side panel.

The airfoil of any preceding clause, wherein the side panel is a first side panel, and wherein the outer shell body includes a second side panel opposite the first side panel, further including a second plurality of recesses formed on an inner surface of the second side panel.

The airfoil of any preceding clause, wherein the structure is a spar in the interior cavity.

The airfoil of any preceding clause, further including a beam in the interior cavity, the beam coupled to and cantilevered from a spar in the interior cavity.

The airfoil of any preceding clause, wherein the structure is the beam.

The airfoil of any preceding clause, wherein the beam has a first portion with a uniform thickness coupled to the spar, and a second portion with a thickness that decreases from the first portion to a distal end of the beam.

The airfoil of any preceding clause, wherein the power-law profile is a first power-law profile, and wherein the thickness of the second portion decreases according to a second power-law profile.

The airfoil of any preceding clause, further including a damping material disposed along the second portion of the beam.

The airfoil of any preceding clause, further including: a root; a plurality of posts in the interior cavity, the plurality of posts coupled to and cantilevered from the root; and a corrugated sheet in the interior cavity, the corrugated sheet engaged with the plurality of posts to dampen vibrations in the airfoil via frictional damping.

The airfoil of any preceding clause, further including: a root; a plurality of posts in the interior cavity, the plurality of posts coupled to and cantilevered from the root; and a plurality of hairpin structures in the interior cavity, each of the plurality of posts disposed between and engaged with two of the plurality of hairpin structures to reduce vibrations in the airfoil via frictional damping.

The airfoil of any preceding clause, wherein the airfoil is a fan blade or an outlet guide vane (OGV) for an unducted turbine engine for an aircraft.

The airfoil of any preceding clause, wherein the recess is circular.

An airfoil comprising an outer shell body defining an interior cavity, a structure in the interior cavity, and a beam disposed in the interior cavity and cantilevered from the structure. The beam has a first portion with a constant thickness and a second portion with a thickness that decreases to a distal end of the beam.

The airfoil of any preceding clause, wherein the thickness of the second portion of the beam decreases to the distal end according to a power-law profile represented by kx^{m}, where m is a real constant defining the power-law profile, x is an axial coordinate along the beam, and k is a constant

The airfoil of any preceding clause, wherein the airfoil includes a damping material disposed on the second portion of the beam.

The airfoil of any preceding clause, wherein the structure is a spar in the interior cavity.

The airfoil of any preceding clause, wherein the airfoil includes a plurality of beams in the interior cavity, wherein a first set of the plurality of beams are coupled to and cantilevered from a forward spar in the interior cavity, and wherein a second set of the plurality of beams are coupled to and cantilevered from a rear spar in the interior cavity.

An airfoil for a turbo engine, the airfoil comprising an outer shell body defining an interior cavity, a root, a plurality of posts in the interior cavity, the plurality of posts coupled to and cantilevered from the root, and a corrugated sheet in the interior cavity, the corrugated sheet engaged with the posts to dampen vibrations in the airfoil via frictional damping.

The airfoil of any preceding clause, wherein the corrugated sheet is pre-strained.

The airfoil of any preceding clause, wherein the posts include a first set of posts on one side of the corrugated sheet and a second set of posts on an opposite side of the corrugated sheet.

The airfoil of any preceding clause, wherein the first set of posts are constructed of a first type of material and the second set of posts are constructed of a second type of material different than the first type of material.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An airfoil, comprising:
an outer shell body defining an interior cavity;
a recess formed on a surface of a structure in the interior cavity; and
an opening in the structure at a center of the recess, wherein the recess defines a thickness of the structure that decreases toward the center according to a power-law profile to concentrate vibrational waves toward the center and reduce vibrations in the airfoil.

2. The airfoil of claim 1, wherein the opening is filled with viscoelastic material.

3. The airfoil of claim 1, wherein the outer shell body includes a side panel, and wherein the surface is an inner surface of the side panel.

4. The airfoil of claim 3, further including a first plurality of recesses formed on the inner surface of the side panel.

5. The airfoil of claim 4, wherein the side panel is a first side panel, and wherein the outer shell body includes a second side panel opposite the first side panel, further including a second plurality of recesses formed on an inner surface of the second side panel.

6. The airfoil of claim 1, wherein the structure is a spar in the interior cavity.

7. The airfoil of claim 1, further including a beam in the interior cavity, the beam coupled to and cantilevered from a spar in the interior cavity.

8. The airfoil of claim 7, wherein the structure is the beam.

9. The airfoil of claim 7, wherein the beam has a first portion with a uniform thickness coupled to the spar, and a second portion with a thickness that decreases from the first portion to a distal end of the beam.

10. The airfoil of claim 9, wherein the power-law profile is a first power-law profile, and wherein the thickness of the second portion decreases according to a second power-law profile.

11. The airfoil of claim 9, further including a damping material disposed along the second portion of the beam.

12. The airfoil of claim 1, further including:
a root;
a plurality of posts in the interior cavity, the plurality of posts coupled to and cantilevered from the root; and
a corrugated sheet in the interior cavity, the corrugated sheet engaged with the plurality of posts to dampen vibrations in the airfoil via frictional damping.

13. The airfoil of claim 1, further including:
a root;
a plurality of posts in the interior cavity, the plurality of posts coupled to and cantilevered from the root; and
a plurality of hairpin structures in the interior cavity, each of the plurality of posts disposed between and engaged with two of the plurality of hairpin structures to reduce vibrations in the airfoil via frictional damping.

14. The airfoil of claim 1, wherein the airfoil is a fan blade or an outlet guide vane (OGV) for an unducted turbine engine for an aircraft.

15. The airfoil of claim 1, wherein the recess is circular.

16. An airfoil, comprising:
an outer shell body defining an interior cavity;
a structure in the interior cavity; and
a beam disposed in the interior cavity and cantilevered from the structure, the beam having a first portion with a constant thickness and a second portion with a thickness that decreases to a distal end of the beam.

17. The airfoil of claim 16, wherein the thickness of the second portion of the beam decreases to the distal end according to a power-law profile represented by kx^{m}, where m is a real constant defining the power-law profile, x is an axial coordinate along the beam, and k is a constant.

18. The airfoil of claim 16, wherein the airfoil includes a damping material disposed on the second portion of the beam.

19. The airfoil of claim 16, wherein the structure is a spar in the interior cavity.

20. The airfoil of claim 16, wherein the airfoil includes a plurality of beams in the interior cavity, wherein a first set of the plurality of beams are coupled to and cantilevered from a forward spar in the interior cavity, and wherein a second set of the plurality of beams are coupled to and cantilevered from a rear spar in the interior cavity.
